(19) United States
(12) Patent Application Publication
(10) Pub. No.: US 2005/0043864 A1
(43) Pub. Date: Feb. 24, 2005

(54) System and method for customizing an audio message system within a vehicle

(76) Inventor: Patti F. Echtenkamp, Jackson, NE (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/646,155

(22) Filed: Aug. 22, 2003

(51) Int. Cl. G06F 17/00

(52) U.S. Cl. 701/1; 701/36

(57) ABSTRACT

A method and system for customizing an audio message system within a vehicle are disclosed. A computing device is in communication with a user interface. A display on the user interface provides a menu having a plurality of selectable audio messages. In one embodiment, the computing device accesses a remote network to provide the menu. The user selects which messages the user would like active via the user interface. The selected messages are stored in a memory storage device. The memory storage device is optionally an internal memory storage device or a portable memory storage device or optionally located on a remote network. The selected messages can be stored as a profile in the memory storage device. An identifying means associates a profile with an individual user. The identifying means can activate a profile such that the selections of the profile are executed upon the occurrence of the triggering event.

### FIELD OF THE INVENTION

The present invention relates to a method and a system for customizing an audio message system within a vehicle, and more specifically to a method and a system for customizing an audio message system within a vehicle wherein a plurality of audio messages are displayed, selected, and selectively activated.

### BACKGROUND OF THE INVENTION

Modern vehicles often include various customization systems which allow the user to customize specific options within the vehicle. Some customization systems allow the user to change settings for parameters such as suspension, steering, and braking via a user interface on a control panel within the control of the user. Other conventional vehicle customization systems allow a user to customize the vehicle climate, audio and video disc players, power windows, mirrors, door locks, clocks, interior and exterior lights via voice command or via an interface on the console. Although these systems allow the user to customize certain parameters of the vehicle, these systems do not allow one to selectively activate and deactivate specific audio messages/warnings within the audio message system of the vehicle.

For example, U.S. Pat. No. 6,230,084, issued to Kijima et al., discloses a method for personalizing the characteristics of a vehicle prior to purchasing the vehicle. A simulation system is disclosed wherein a purchaser of a new vehicle is guided through a set of simulated driving conditions. The simulated driving conditions may vary from urban conditions to icy country driving. A storage means stores the associated driving parameters. The stored information includes properties such as suspension, steering, engine output, transmission, braking, and seat adjustments. In another embodiment, the vehicle settings are entered manually via a keyboard or other input device. The data is stored then read directly or indirectly by the control unit of the vehicle to change the characteristics of the vehicle. While there is disclosed a system for selecting a number of different vehicle parameters, there is not disclosed a means of selectively activating the audio messages of the vehicle.

Other conventional vehicle customization systems are known which utilize audio components to customize vehicle settings or convey information to the vehicle user. However, these systems do not allow the user to specifically select which audio messages/warnings he or she will hear upon the occurrence of a triggering event.

For example, U.S. Pat. No. 6,240,347, issued to Everhart et al., discloses a system for controlling vehicle electronic accessories such as navigation systems, audio systems, climate control systems, audio and video disc players, power windows and mirrors, door locks, clocks, interior and exterior lights, information gauges and displays, and powered positioning of seats, steering wheels, and floor pedals. To change settings, the user optionally utters a voice command such as “audio volume,” “bass,” “tune,” “seek,” “temperature,” “fan,” “clock set,” and “navigation” to identify a parameter for adjustment. The command is received by a speech processor which employs voice recognition techniques to recognize spoken sounds and to transmit corresponding commands to controllable accessories via a multiplex network. The user is then able to adjust a parameter by further verbal commands, steering wheel switches, or by push buttons on the central display/control unit. Everhart further discloses a means of sending synthesized audio messages that provide feedback about functions being controlled or the state of the controls. While the user controls which audio messages may be heard at a given time by using specific verbal commands or may change settings using verbal commands, Everhart does not disclose any means of controlling audio messages which are only heard upon the occurrence of a triggering event, such as various types of warning messages.

Additionally, U.S. Pat. No. 6,449,535, issued to Obradovich et al., discloses an information and control system for a vehicle which utilizes an audio output to convey information to the user and allows the user to change vehicular settings via voice command. In a preferred embodiment, the user selects from a plurality of selectable options on a display screen. Each option corresponds to information about a given part or accessory of the automobile. When the user selects an option, a voice is generated which informs the user of the purpose or content of the selected option. The user may then activate the selected option and information about the selected option is provided in both audio and visual format. In another embodiment, the user may selectively change settings such as for security, door locks, climate, radio/CD, instrument panel displays, clock, lights, mirrors, windows, cruise control, and others by voice command or via a touch pad on a control panel. While the user controls which audio messages may be heard at a given time by using specific verbal commands or may change settings using verbal commands, Obradovich does not disclose any means of controlling audio messages which are heard upon the occurrence of a triggering event.

Other conventional systems which relate to an audio message system of a vehicle are known, but such systems merely prioritize the audio messages of the system and do not disclose any means of allowing a user to select which messages he or she will hear upon the occurrence of a triggering event. For example, U.S. Pat. No. 6,289,332, issued to Menig et al., discloses an integrated message display system for a vehicle. There is an audio-visual messaging system has a plurality of sensors throughout the vehicle which receive and communicate information regarding operating conditions of the vehicle to an instrumentation control unit. In response, the instrumentation control unit prioritizes and outputs the audio or visual alert with the highest priority. There are four levels of alerts: Level 1 “Danger,” Level 2 “Warning,” Level 3 “Caution,” Level 4 “Note,” or “Message.” A Level 1 warning is very serious and necessitates an immediate reaction by the driver. A Level 2 warning indicates a very serious problem. Each of the four levels of alerts is associated with a predetermined message protocol, which determines the number of tones, duration of the audio or visual alert, and tone frequency. After a predetermined amount of time, the driver can turn off the alert by pressing an “acknowledgement” key on a touch pad on the message center. The system aids a driver in effectively using a plurality of vehicle operating and diagnostic tools via prioritizing the visual and audio outputs for the driver.

In another embodiment, a collision warning system having a prioritization scheme of its own is integrated into the system's message scheme. The collision warning system communicates collision warning conditions to the instrumentation control unit. The collision warning system includes a front sensor, a side sensor, side sensor display, an on/off switch, volume control, and collision warning range/adaptive cruise headway control. A programmed CPU on the collision warning system electronic control unit receives information about nearby objects from the front sensor and side sensor, computes collision warning conditions, and communicates warnings to the instrumentation control unit. The instrumentation control unit determines whether to override the current alert based on the priority of the alert and the current message. The system also integrates adaptive cruise control messages and transmission messages into the system's centralized message scheme. While Menig discloses a system which prioritizes the audio messages of the system, Menig does not disclose a way to selectively activate the audio messages of a vehicle such that only selected messages are heard upon the occurrence of a triggering event.

Therefore, it would be advantageous to provide a system and a method for choosing, storing, and selectively activating audio messages of an audio message system of a vehicle such that only selected audio messages are heard upon the occurrence of a triggering event.

### SUMMARY OF THE INVENTION

In view of the deficiencies described above, disclosed is a system and a method for choosing, storing, and selectively activating audio messages of an audio message system of a vehicle such that only selected audio messages are heard upon the occurrence of a triggering event.

The present invention is a method and a system for selectively activating the audio messages of a vehicle such that only selected messages are heard upon the occurrence of a triggering event. In the system, there is a computing device disposed within a vehicle. The computing device is in communication with a user interface. The user interface has a display which provides a menu of selectable audio warnings/messages for the vehicle. The audio messages optionally inform the vehicle owner of some predetermined condition intended to induce action by the user, or optionally conveys any other predetermined information.

The user selects which messages the user would like active at a given time from the menu on the user interface. The selected messages are communicated from the computing device to a memory storage device to store the selected warnings/messages. The memory storage device can be an internal memory storage device in communication with the computing device or is a portable memory storage device such as a floppy disk, rewritable CD, memory storage card, or any other suitable means.

In yet another embodiment, the computing device accesses a remote network to provide the menu on the user interface. A menu of selectable audio messages is accessed and is displayed on the user interface. The user selects which messages he or she would like active at a particular time via the user interface. The selected messages are then communicated from the computing device to a memory storage device to store the selected messages. The selected messages are optionally stored on an internal memory storage device or on a portable memory storage device. Additionally, there is optionally a memory storage device located on the remote network and the selected messages can be stored at a remote location.

When any group of selected messages is stored, the selections can be stored as a profile for the user. For any stored profile, the system can have an identifying means for associating a specific profile with a corresponding user. When a profile is activated by the identifying means, the selected audio messages of the profile are executed upon the occurrence of a triggering event corresponding to the audio message.

Other features and advantages of the invention will be apparent from the following detailed description taken in conjunction with the following drawings.

### BRIEF DESCRIPTION OF THE DRAWINGS

FIG. 1 illustrates a first embodiment of the present invention in block diagram form.

FIG. 2 illustrates a second embodiment of the present invention in block diagram form.

FIG. 3 illustrates a first method of the present invention.

FIG. 4 illustrates a second method of the present invention.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is a system and a method for choosing, storing, and selectively activating audio messages of an audio message system of a vehicle such that only selected audio messages are heard upon the occurrence of a triggering event.

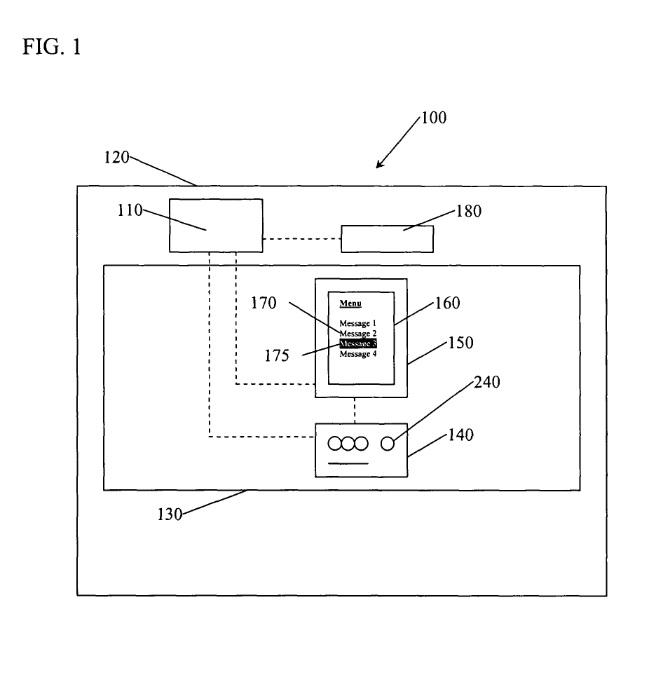

A first embodiment of the present invention is shown in FIG. 1 in block diagram form. The actual appearance, location, and formatting of the present invention is highly variable, thus a block diagram form of the present invention is most representative. In the system 100, there is a computing device 110 within a vehicle 120. Preferably, the computing device 110 is a processor which is disposed in the front console 130 of the vehicle 120. The computing device 110 is in communication with a user interface 140 which is also preferably disposed in the front console 130. The user interface 140 has a display 150 which provides a menu 160 of selectable audio messages 170 for the vehicle 120. The user interface 140 and display 150 may be co-located or separately located. Potential locations for the user interface 140 and display 150 include, but are not limited to, the front console 130, the vehicle instrument cluster, an overhead console, a center console, and the vehicle steering wheel.

The selectable audio messages 170 optionally inform the vehicle user of some predetermined warning intended to induce action by the user. For example, the selectable audio messages 170 optionally inform the user that a blinker is still on, tire pressure is too low, of a need for oil, or of any other condition which may require a response from the user. Optionally, the selectable audio messages 170 inform the user of any other predetermined information of interest to the user, such as the outside air temperature, or that one or more of the passengers is not wearing their seatbelt, or other like type of messges.

The user selects which messages he or she would like active at a given time from the menu 160 on the user interface 140. The selected audio messages 175 are communicated from the computing device 110 to a memory storage device 180 to store the selected audio messages 175. The memory storage device 180 is optionally an internal memory storage device in communication with the computing device 110. Alternatively, the memory storage device 180 is a portable memory storage device, not shown, such as a floppy disk, rewritable CD, memory storage card, or any other suitable portable memory storage device.

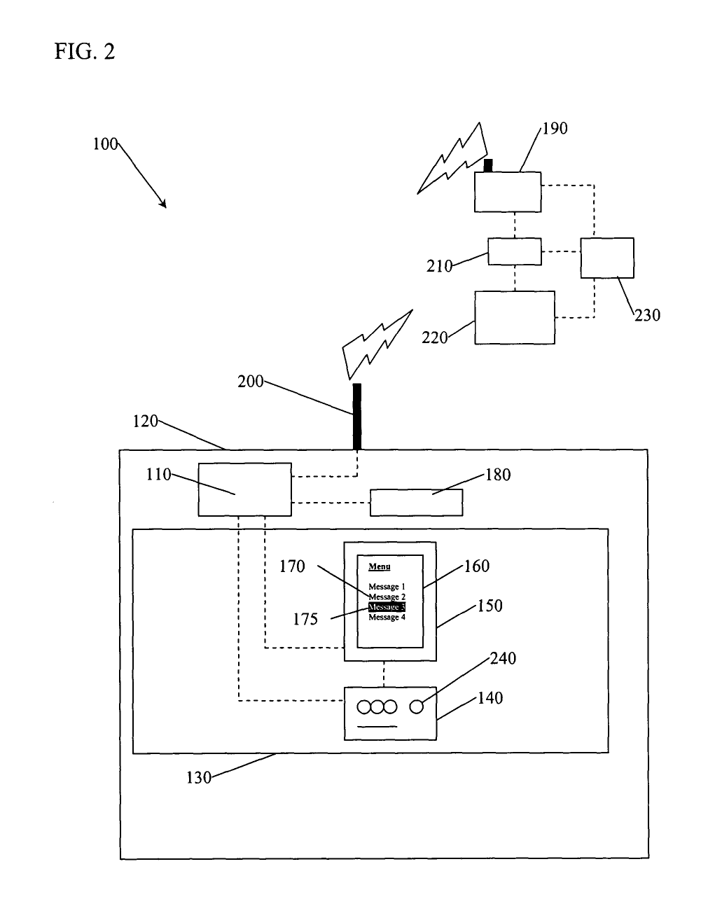

In other embodiments, shown in block diagram form in FIG. 2, the computing device 110 accesses a remote network 190 to provide the menu 160 on the user interface 140. Optionally, the computing device 110 has a communication means 200 to contact an internet service provider (“ISP”) 210. For example, upon starting the vehicle 120, the computing device 110 optionally accesses a remote network 190 via the ISP 210 and links to a third party website 220 which may be a website controlled by the vehicle manufacturer, a safety organization (e.g., OSHA), law enforcement officials or other governmental officials, or like types of organizations. A menu 160 of selectable audio messages 170 is accessed and is displayed on the user interface 140. The user selects which messages he or she would like active at a particular time via the user interface 140. The selected audio messages 175 are then communicated from the computing device 110 to a memory storage device 180 to store the selected audio messages 175. The selected audio messages 175 are optionally stored on an internal memory storage device or on a portable memory storage device, not shown. Additionally, there can be a remote memory storage device 230 located on the remote network 190 and the selected audio messages 175 are stored at a remote location. The remote location may be the vehicle manufacturer's network, not shown, or any other suitable location remote from the vehicle 120.

When a group of selected audio messages 175 is stored, the selections can be stored as a profile for the user. For any stored profile, the system 100 has an identifying means 240 for associating a specific profile with a corresponding user. In various embodiments, the identifying means 240 optionally comprises a password having at least one character which is entered on the user interface 140. In other embodiments, the identifying means 240 is a push button, shown, on the user interface 140. In yet other embodiments, the identifying means 240 is stored on a portable memory storage device, not shown, such as a CD, disc, SMART CARD, or any other suitable means. When a profile is activated by the identifying means 240, the selected audio messages 175 of the profile are executed upon the occurrence of a triggering event corresponding to the audio message. Thus, for example, when a user activates the audio message “Your blinker is on,” the user will hear that audio message upon the occurrence of leaving a blinker on.

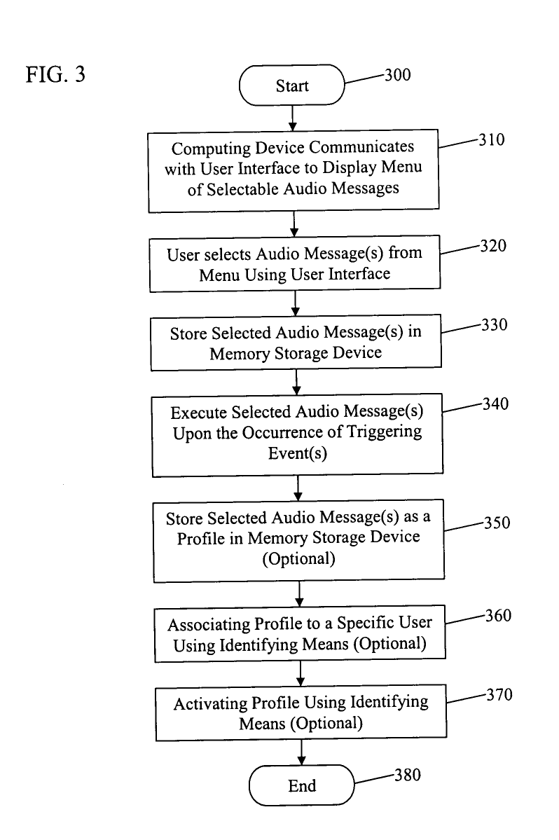

There is further disclosed a method for customizing an audio message system within a vehicle, an embodiment of which is shown in FIG. 3. The method starts at step 300. At step 310 the computing device 110 communicates with the user interface 140 to display the menu 160 of selectable audio messages 170 on the display 150. At step 320, the user selects audio messages from the menu 160 using the user interface 140. At step 330, the selected audio messages 175 are stored in the memory storage device 180. At step 340, the selected audio messages are executed upon the occurrence of a triggering event. At optional step 350, the selected audio messages 175 are stored as a profile in the memory storage device 180. At optional step 360, an identifying means 240 is used to associate the stored profile with a specific user. At optional step 370, the identifying means 240 is used to activate the stored profile. Lastly, the method ends at step 380.

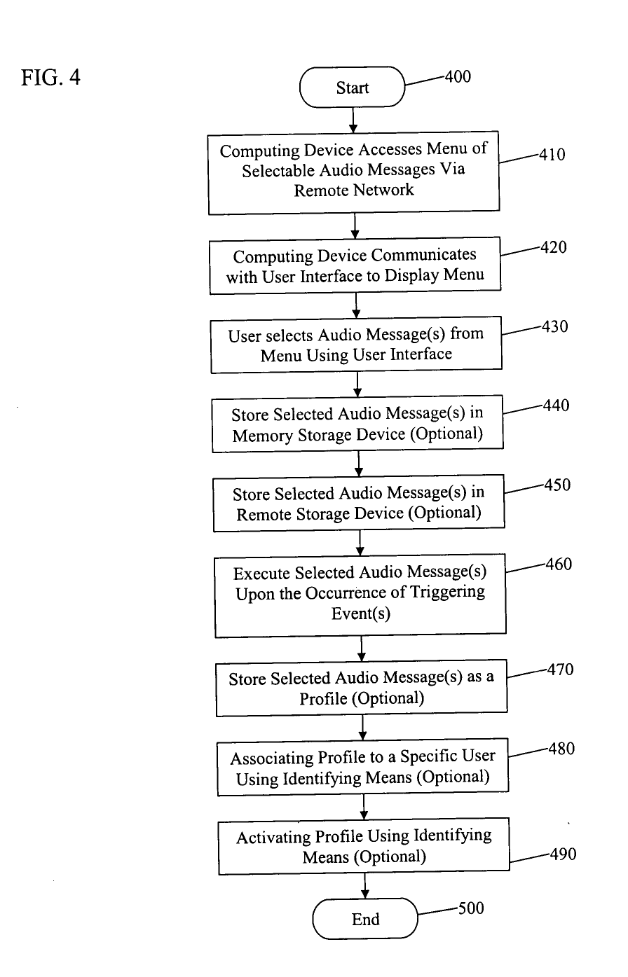

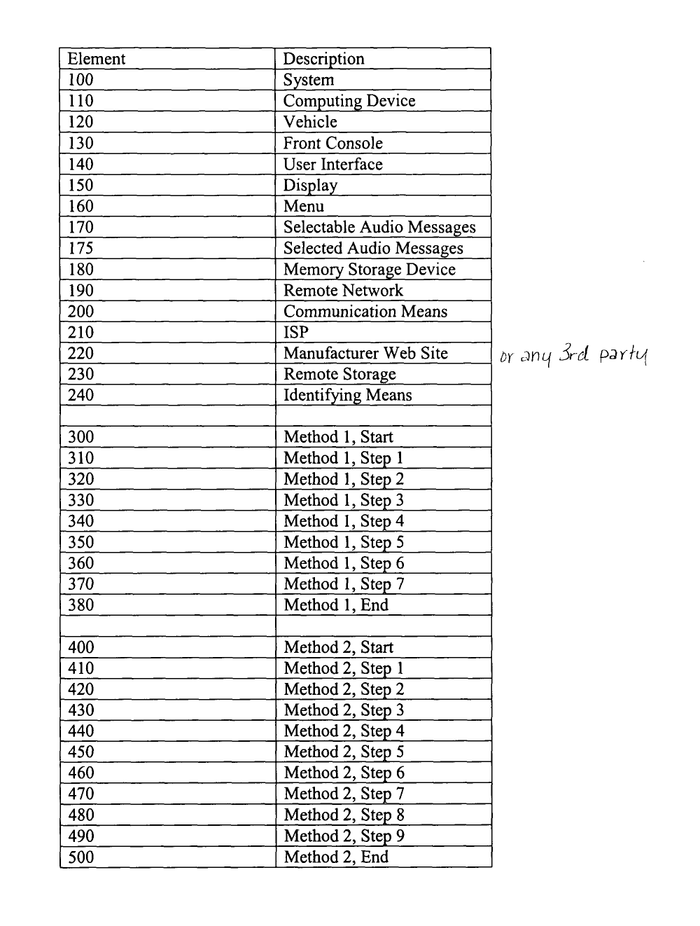

Other embodiments of the method for customizing an audio message system within a vehicle are shown in FIG. 4. The method starts at step 400. At step 410 the computing device 110 accesses the menu 160 of selectable audio messages 170 via a remote network 190. At step 420, the computing device 110 communicates with the user interface 140 to display the menu 160 of selectable audio messages 170 on the display 150. At step 430, the user selects audio messages from the menu 160 using the user interface 140. At steps 440 and 450, the selected audio messages 175 are optionally stored in the memory storage device 180 or in the remote storage device 230. At step 460, the selected audio messages are executed upon the occurrence of a triggering event. At optional step 470, the selected audio messages 175 are stored as a profile in at least one of the memory storage device 180 or the remote storage device 230. At optional step 480, an identifying means 240 is used to associate the stored profile with a specific user. At optional step 490, the identifying means 240 is used to activate the stored profile. Lastly, the method ends at step 500.

While the specific embodiments have been illustrated and described, numerous modifications come to mind without significantly departing from the spirit of the invention, and the scope of protection is only limited by the scope of the accompanying claims.

1. A system for customizing an audio message within a vehicle comprising:
a computing device disposed within a vehicle,
a user interface in communication with said computing device,
a display in communication with said computing device and said user interface comprising a menu, wherein a user makes selections comprising audio messages from the menu using the user interface,
a memory storage device in communication with said computing device for storing at least one of said selections from said menu, and
a means for enabling the execution of a message selected by a user upon the occurrence and detection of a triggering event.

2. The system according to claim 1, wherein said memory storage device is a portable memory storage device.

3. The system according to claim 2, wherein said portable memory storage device comprises a portable memory storage card.

4. The system according to claim 1, wherein said memory storage device is an internal memory storage device.

5. The system according to claim 1, further comprising a means for accessing a remote network to provide said menu, wherein such a user selects one or more of said selections from said menu via said user interface.

6. The system according to claim 5, wherein said means for accessing a remote network comprises a means for accessing a website of the manufacturer of the vehicle via an internet service provider to provide said menu.

7. The system according to claim 5, wherein said memory storage device is located on said remote network.

8. The system according to claim 5, wherein said memory storage device is a portable memory storage device.

9. The system according to claim 8, wherein said portable memory storage device comprises a portable memory storage card.

10 The system according to claim 5, wherein said memory storage device is an internal memory storage device.

11. The system according to claim 1, wherein said audio messages correspond to a condition of said vehicle.

12. The system according to claim 11, wherein at least one of said audio messages informs the user that a vehicle light is activated.

13. The system according to claim 11, wherein at least one of said audio messages informs the user that a door is ajar within said vehicle.

14. The system according to claim 11, wherein at least one of said audio messages informs said user that the vehicle is in need of oil.

15. The system according to claim 11, wherein at least one of said audio messages informs the user that at least one tire of said vehicle is in need of air.

16. The system according to claim 11, wherein at least one of said audio messages informs the user that the battery of the vehicle is in need of replacement.

17. The system according to claim 11, wherein at least one of said audio messages informs the user of a condition external of the vehicle.

18. The system according to claim 11, wherein at least one of said audio messages informs the user of the air temperature outside of the vehicle.

19. The system according to claim 1, further comprising providing an identifying means for associating a profile comprising at least one of said selections with an individual user, and wherein said identifying means activates said profile such that the selections of said profile are executed upon the occurrence of the triggering event.

20. The system according to claim 19, wherein said identifying means is a password comprising at least one character which is entered on said user interface.

21. The system according to claim 19, wherein said identifying means is a push button on said user interface.

22. The system according to claim 19, wherein said identifying means is stored on a portable memory storage device card.

23. A method for customizing an audio message system within a vehicle comprising:
providing a computing device within a vehicle,
providing a user interface in communication with said computing device within the vehicle,
enabling a user to make selections comprising audio messages from a menu using the user interface,
storing at least one of said selections within a memory storage device, and
enabling the execution of said at least one selection stored within said memory device upon the occurrence of a triggering event.

24. The method according to claim 23, wherein said memory storage device is a portable memory storage device.

25. The method according to claim 24, wherein said portable memory storage device comprises a portable memory storage card.

26. The method according to claim 23, wherein said memory storage device is an internal memory storage device.

27. The method according to claim 23, wherein said menu is provided by accessing a remote network, and wherein such a user selects one of said selections from said menu via said user interface.

28. The method according to claim 27, wherein said memory storage device is located on said remote network.

29. The method according to claim 27, wherein the step of accessing a remote network comprises accessing a website of the manufacturer of the vehicle via an internet service provider to provide said menu.

30. The method according to claim 27, wherein said memory storage device is a portable memory storage card for storing said selection.

31. The method according to claim 30, wherein said portable memory storage device comprises a portable memory storage card.

32. The method according to claim 27, wherein said memory storage device is an internal memory storage device for storing said selection.

33. The method according to claim 27, wherein said audio messages correspond to a specific condition of said vehicle.

34. The method according to claim 33, wherein at least one of said audio messages informs the user that a vehicle light is activated.

35. The method according to claim 33, wherein one of said audio messages informs the user that a door is ajar within said vehicle.

36. The method according to claim 33, wherein one of said audio messages informs said user that the vehicle is in need of oil.

37. The method according to claim 33, wherein one of said audio messages informs the user that at least one tire of said vehicle is in need of air.

38. The method according to claim 33, wherein one of said audio messages informs the user that a battery of the vehicle is in need of replacement.

39. The method according to claim 33, wherein at least one of said audio messages informs the user of a condition external of the vehicle.

40. The method according to claim 33, wherein at least one of said audio messages informs the user of the air temperature outside of the vehicle.

41. The method according to claim 23, further comprising providing an identifying means for associating a profile comprising at least one of said selections with an individual user, and wherein said identifying means activates the profile such that the selections of the profile are executed upon the occurrence of the triggering event.

42. The method according to claim 41, wherein said identifying means is a password comprising at least one character which is entered on said user interface.

43. The method according to claim 41, wherein said identifying means is a push button on said user interface.

44. The method according to claim 41, wherein said identifying means is stored on a portable memory storage device card.
